(19) United States
(12) Patent Application Publication
(10) Pub. No.: US 2016/0092879 A1
(43) Pub. Date: Mar. 31, 2016

(54) Switch Server System Interoperable With Mobile Devices Providing Secure Communications For Transactions

(71) Applicant: Jack W. Lasersohn, East Hampton, NY (US)

(72) Inventor: Jack W. Lasersohn, East Hampton, NY (US)

(21) Appl. No.: 14/866,099

(22) Filed: Sep. 25, 2015

Related U.S. Application Data
(60) Provisional application No. 62/056,350, filed on Sep. 26, 2014.
(60) Provisional application No. 62/063,907, filed on Oct. 14, 2014.

(51) Int. Cl. G06Q 20/40

(52) U.S. Cl. CPC G06Q 20/4014; G06Q 2220/00

(57) ABSTRACT

Methods and systems for conducting a secure transaction over a network using one or more gateway servers. The methods include exchanging first cryptographic information with a user. The first cryptographic information adapted to encrypt and decrypt communications. The methods further include receiving, from the user, identifying information associated with the user. The methods also include validating the identifying information and converting the user to a participating user after the validating operation. The methods include exchanging second cryptographic information with the participating user. The second cryptographic information adapted to encrypt and decrypt communications. The methods also include receiving, from the participating user, encrypted personal data being encrypted using the second cryptographic information. The encrypted personal data being received via a data equity programmable user interface. The methods include performing a transaction with the user in accordance with an encrypted payment authorization.

### CROSS-REFERENCE TO RELATED APPLICATIONS

This application claims priority to co-pending U.S. Provisional Patent Application Ser. No. 62/056,350, filed Sep. 26, 2014, and co-pending U.S. Provisional Patent Application Ser. No. 62/063,907, filed Oct. 14, 2014, which are entirely incorporated herein by reference for all purposes.

### FIELD OF INVENTION

The present technology relates to transactions and data comparisons. In particular, the present technology provides a switch server system interoperable with mobile devices for providing secure communications for transactions and data comparisons.

### SUMMARY

Some embodiments of the present technology include systems and methods for conducting a secure transaction over a network using one or more gateway servers. Embodiments of the method include a secure switch operable to communicate bilaterally with at least one consumer application. Systems and methods also include at least one gateway server electronically communicating with the secure switch and including a processor and a memory communicatively coupled to the processor, the memory storing instructions executable by the system to perform a method. Systems and methods further include exchanging first cryptographic information with a user. The first cryptographic information adapted to encrypt and decrypt communications. Systems and methods also include receiving, from the user, identifying information associated with the user. Systems and methods further include validating the identifying information and converting the user to a participating user after the validating operation.

Various embodiments of the present technology include exchanging second cryptographic information with the participating user. The second cryptographic information adapted to encrypt and decrypt communications. Systems and methods further include receiving, from the participating user, encrypted personal data being encrypted using the second cryptographic information. The encrypted personal data being received via a data equity programmable user interface. Systems and methods also include confirming the encrypted personal data to transform the encrypted personal data to decrypted personal data. Systems and methods further include the confirming of the encrypted personal data including decrypting, by the system, the encrypted personal data using the second cryptographic information.

Some embodiments of the present technology include sending a payment message to a mobile device associated with the user. The payment message being encrypted by the system using the first cryptographic information to form an encrypted payment message. Systems and methods also include receiving, from the mobile device, an encrypted payment authorization associated with the payment message, the encrypted payment authorization being encrypted using the first cryptographic information, being decrypted by the system using the first cryptographic information. Systems and methods also include performing a transaction with the user in accordance with the encrypted payment authorization.

Various embodiments of the present technology include at least one application programming interface electronically communicating with the at least one gateway server and adapted to communicate bilaterally with that at least one consumer application.

### BRIEF DESCRIPTION OF THE DRAWINGS

FIG. 1 is a simplified block diagram of a system according to exemplary embodiments of the present technology;

FIG. 2 is a simplified block diagram of a system according to exemplary embodiments of the present technology;

FIG. 3A is a flow diagram illustrating an example method according to exemplary embodiments of the present technology;

FIG. 3B is a flow diagram illustrating an exemplary method according embodiments of the present technology;

FIG. 4 illustrates a computer system according to exemplary embodiments of the present technology.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

The present technology includes methods and/or systems for exchanging data for an equity financial interest in a company that uses the data. In some embodiments, an individual person fully owns and controls personal data, or an individual person has use, disposition, and/or partial legal control of personal data. According to some embodiments, a user of the system is the individual person partially or fully owning or controlling their personal data. In various embodiments the personal data is partially owned, controlled and/or in the possession of a third-party and an individual grants permission to access the personal data. For example, personal data of an individual may be stored in a database and the individual grants access to their personal data in the database in exchange for an equity financial interest in a company that uses the personal data.

In various embodiments, personal data is an individual's whole or partial genome sequence data and their whole or partial personal electronic medical records. An individual's genome sequence data is an example of personal data that an individual may fully or partially own and control. An individual's electronic medical records (which may include drug prescriptions, drug usage data and drug outcome data) are an example of personal data over which an individual has partial control. For example, without the explicit permission of the individual, an insurance company or healthcare provider may access an individual's medical records for some purposes. In contrast, an individual must authorize certain uses or disposition of their personal medical records or portions thereof for other purposes, such as research. Thus, even though an individual has access rights under federal law to their personal medical records only certain uses or disposition of their medical records is subject to their legal control.

It is understood that a person has authority over the use or disposition of data, both where the person must consent affirmatively to such use or disposition, and where the person may deny or withdraw consent that may have been deemed conditionally granted by law or otherwise. Those with ordinary skill in the art will understand that systems in which consent must be affirmatively granted are sometimes called “Opt-in” systems and those where consent is deemed granted, but may be withdrawn or denied by the person, are sometimes called “Opt-out” systems. Opt-in and Opt-out types of systems are included as authorizations herein.

In some embodiments, personal data is protected health information under federal laws such as the Health Insurance Portability and Accountability Act (“HIPPA”) and/or applicable state laws. Protected health information is generally medical records containing information that could permit identification of the individual who is the subject of the record. Federal and state laws and regulations require an individual's authorization for certain uses of his/her protected health information, such as for research. A limited data set is a subset of a medical record from which certain types of data that may be used to identify the subject individual has been removed. Under various federal and state laws and regulations, a limited data set generally may be used for research without the consent from the subject individual. Certain genetic information about an individual, however, may be used to identify the individual. Therefore, the combination of an otherwise limited data set with genetic information sufficient to reasonably identify the individual produces a medical record that is protected health information. Consequently, such protected health information is subject to the individual's legal control for certain purposes such as research.

In various embodiments, in addition to genetic information other types of biological or pheno typical data about an individual may enable identification of the individual, and the combination of such data with an otherwise limited data set of medical information produces a protected health information data set of the individual. Non-limiting examples of biological or phenotype data include proteins and peptides (foreign or self-produced), chemicals, microbes and viruses present in an individual's body, an individual's microbiome as well as observations or measurements of an individual's health such as an Electrocardiography (“EKG”), an Electroencephalography (“EEG”), and psychological or intelligence tests. Additional non-limiting examples of biological or phenotype data include commonly used identifiers such as fingerprints, pictures, retinal scans as well as images from Magnetic Resonance Imaging (“MRI”), Nuclear Magnetic Resonance Imaging (“NMRI”), Magnetic Resonance Tomography (“MRT”), Computed Tomography (“CT”), and other types of data from medical imaging or monitoring systems. Additional non-limiting examples of biological or phenotype data include personal traits such as Intelligence Quotient (IQ) test results, results of personality and psychological tests, and all other measures of personal attributes which may be used to compare an individual person with a larger human population.

According to various embodiments, personal data is individually generated content. By way of non-limiting examples, individually generated content may be images, art, books, reviews, comments, observations and/or opinions. Individually generated content may be a personal review or opinion of consumer products, professional services, or any product or service for which an individual generates content. For example, an individual may generate a review of a physician and exchange that review for equity in company that uses the physician review. Groups of individuals may generate content and exchange that content for equity based on agreement among such individuals as to the distribution of such equity among themselves.

In some embodiments, healthcare workers such as nurses, nurse anesthesiologists, technicians, physicians, or others who are present or observe a surgical or interventional procedure provide individually generated content of a review or personal opinion about the skill of the surgeons or physicians performing the procedure. In some instances, such review or opinion includes a score on a pre-specified scoring system reflecting various elements relevant to assessing the surgeon's or physician's skill, and such scores are used by an algorithm to create a score reflecting the relative ranking of various surgeons and physicians within the database. In other instances, the score correlates (to some stated degree) with measures of clinical outcome. Scores provided by an individual healthcare worker concerning a specific surgeon or physician are compared to scores from other healthcare workers concerning the same surgeon or physician. Further, the scores may be adjusted or weighted in the final scoring algorithm depending on the degree of concordance or discordance with other scores.

According to some embodiments, the methods/systems described herein use equity architecture to aggregate all the data or a subset of all the data from all the users or a subset of all the users. In some instances, the company is a genetic data/medical records “co-operative” or “mutual company.” In other instances, the company is an individually generated content “co-operative” or “mutual company.” A person of ordinary skill in the art will understand that a “co-operative” is a business that is partially or fully owned by people that contribute the data. Similarly, a “mutual company” is partially or fully owned by and/or run for the benefit of the people that contribute the data.

In various embodiments, personal data is transacted for an equity financial interest in a for-profit company. The transaction involves personal data over which an individual has legal control and his/her authorization is required by law for use or disposition of such data. The person having legal control or authority grants authorization for at least certain uses and/or dispositions of the personal data to the company for which he/she has transacted for the equity financial interest.

According to some embodiments, the company that receives and/or uses the personal data in exchange for an equity interest in itself is a for-profit company such as a C corporation, S corporation, Limited Liability Corporation, or other for-profit entity formed as a joint-stock company. In some instances, individual people exchange their personal data for an equity financial interest in a for-profit company that receives and/or uses their personal data. For example, an individual person exchanges access to their genomic sequence data and personal electronic medical records for 100 equity shares of a C corporation that uses their personal data with the intent of returning a profit for the owners that include the equity shareholders of the C corporation.

In some embodiments, the equity financial interest is an ownership interest in a company that makes use of personal data such as common equity shares or shares ultimately convertible into common equity. By way of non-limiting examples, the ownership interest may be stock, stock options, restricted shares, dividends, royalties, or any equity ownership interest in a business entity that uses the personal data.

According to various embodiments, a percentage of the total equity in a company is reserved for users or individuals that contribute data to the company (hereinafter “Data Shareholders”). For example, 50% of the total equity in the company is reserved for Data Shareholders and this 50% is a non-dilutable equity interest in the company in perpetuity or until some specified event or date.

In some embodiments, Data Shareholders receive cash payments as a function of the amount and/or value of use of the data provided by them. For example, if the personal data contributed by a Data Shareholder is rented for cash for use by another person, the Data Shareholder receives a cash payment that is a function of the rental payment. In some instances, such cash payment is a reduction in some other payment due from the Data Shareholder, such as a payment for health insurance.

In some embodiments, Data Shareholders who contribute data receive a different form, class, or type of equity than other persons who contribute cash for equity in the company. In such a case, there is a distinction between equity given to Data Shareholders for data (hereinafter “Data Equity”) and other forms of equity in the company. For example, Data Equity has no or limited voting rights or other restrictions on sale or purchases, as compared to other classes or forms of equity in the same company. For further example, title to Data Equity does not vest in a Data Shareholder until a date in the future subsequent to the receipt of personal data from the Data Shareholder.

According to some embodiments, a determination event triggers when the equity financial interest in the company is vested in and/or distributed to the Data Shareholders. For example, the determination event may be a predetermined occurrence for the company such as an Initial Public Offering (hereinafter “IPO”), merger, acquisition, or other exit. For instance, vesting of title in and/or distribution of equity shares to Data Shareholders occurs when the company initiates an IPO, merges, or is acquired. By default, the determination event may be a predetermined future date that triggers vesting of title in and/or distribution of equity shares to the Data Shareholders. For example, the default determination event is five years from formation of the company if the other predetermined events do not occur (i.e. no IPO, merger, acquisition, or other exit triggers the distribution of shares to Data Shareholders before the default date).

In various embodiments, a mutual insurance system as a function of Data Equity provides insurance to the Data Shareholder and/or the entity that uses the personal data. A person of ordinary skill in the art will understand that a mutual insurance system is an insurance system substantially or completely owned by its policyholders. Similarly, a Data Shareholder receives insurance coverage for specified events as a function of that shareholder's Data Equity. In some embodiments, the insurance is optional at the choice of the Data Shareholder. In various embodiments, the insurance is life insurance. For example, the Data Shareholder pays money to purchase a cancellable life insurance policy shortly or immediately before transacting personal data for equity.

According to some embodiments, the equity financial interest in the company is a function of quality and/or quantity of the personal data. For example, the equity financial interest may be proportional to the quality and/or quantity of the personal data provided. In some instances, specific algorithms may be used to calculate quality and/or quantity of the personal data.

According to various embodiments, the equity financial interest in the company is a function of the amount or type of use of the personal data. For example, a larger equity financial interest is given in exchange for data that is used more often by the company, accessed or viewed more often or by more users of the system, or rented or sold for greater value by the company as compared to other personal data.

In some embodiments, a disproportional distribution of equity financial interest is granted to different Data Shareholders. The company may grant equity to Data Shareholders by deterministic categories depending on various factors. By way of non-limiting examples, the various factors include timing, quality, and/or quantity of data provided by Data Shareholders. For example, a Data Shareholder that is first to provide data to the company receives a greater amount of equity in the company than a Data Shareholder who provides similar data at a later date.

According to some embodiments, a person provides or directs another to provide personal data. For example, a user may provide or permit access to the full sequence of the user's genome together with the user's electronic medical record including data about prior and/or current diagnoses or conditions. The user also provides data about traits of the user or data from which estimates of the traits are made. For example, the user provides data about the results of intelligence tests as data about user's intelligence, or the user provides evidence of academic achievement from which estimates of intelligence are made by an algorithm.

In some embodiments, the amount of equity interest granted to the user for data is dependent on the content of the data. For example, a user providing personal data indicating that the user has type-1 diabetes receives a larger equity interest than a user whose personal data indicates he/she does not have type-1 diabetes. Similarly, a user whose genomic sequence indicates the presence of a particular mutation receives a larger equity interest than a user without the mutation.

According to some embodiments, the equity interest in a company using the data is granted only to persons providing personal data containing specifically desired data. For example, only users providing personal data that is positive for a specified condition such as type-1 diabetes are granted Data Equity in the company using the data. In such a case, the equity transacting system examines the data provided by a person and confirms the presence of the required attribute in the data tendered in exchange for equity.

In various embodiments, a platform may aggregate a massive amount of personal data including medical health records, genomic sequence data, other biological or phenotype data, and/or individually generated content. Analysis of aggregated data in a massive database may catalyze insights that are not possible by examining a smaller database. For example, insights from a large database of medical records with corresponding genomic data may lead to understanding of patient disease susceptibility and therapeutic outcomes. Larger databases may permit correlations to be observed among elements of the database with greater levels of statistical certainty or confidence than observations of the same correlations in a smaller database. These correlations may lead to new drugs, diagnostics and therapies.

According to various embodiments, data may exist in many separate databases owned by different owners and stored in different formats. Different users of the data may need to negotiate usage rights with many different owners. Further, different users may need to reformat or correct the data even if this had been done by a previous user. Negotiating with different owners and reformatting data may add substantial cost to the use of the data. Increased costs are especially problematic if the data is going to be used for research purposes because funding to defray increased costs for research is often limited. Thus, a large consolidated database with a centralized data access authorization system and centralized maintenance of data records may reduce the increased costs resulting from multiple smaller databases.

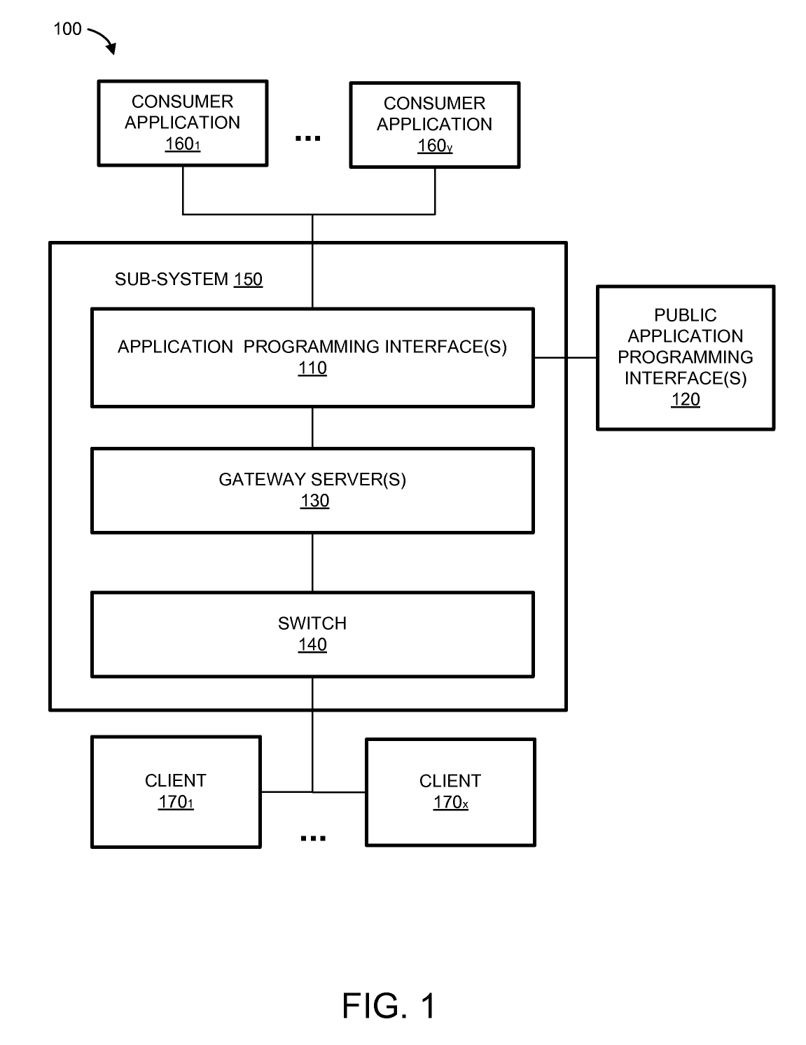

In various embodiments, the individuals and/or entities that own or control the use of the data may be unwilling to allow others to use the data without some form of compensation. Thus, the individuals and/or entities that provide this data from which such benefits are derived receive equity interest in the value of those benefits as a form of compensation. These and other advantages of the present technology are provided in greater detail with reference to the drawings (e.g., FIGS. 1-4).

According to some embodiments, the system may operate in a cloud-based computer environment or, alternatively, may operate as a secure server. All communications to and from mobile devices and other mobile applications may be encrypted and decrypted for security purposes.

According to various embodiments, the application may be a mobile application, and/or may be used on a laptop, smartphone or PDA, wearable device, and may be downloadable or web-based. Alternatively, the system may be implemented in software and/or hardware. A mobile application may be provided that enables a user to access a web-based version of the system from a mobile device.

Generally, the present technology encompasses an application-based personal genetic data analysis and comparison system hereinafter referred to as “application-based genetic data analysis.” The application provides a plurality of graphical user interfaces (GUIs) that allow an individual/user to interact with, and use features of the application.

Broadly speaking, in some embodiments the application (e.g., consumer applications 160₁-160_{y}) provides personal genetic data analysis and comparison for application-based genetic data analysis. The application can be executed within the context of a computing architecture, such as the architecture of FIG. 1, described in greater detail herein. The application can be executed locally on a user device (e.g., clients 170₁-170ₓ), such as a Smartphone or tablet device. Alternatively, the application can be accessed by a user device over a network. Thus, the application can be executed on a server and accessed by the user device using a browser application. The server will serve GUIs of the application as web pages of a standard or mobile website.

According to some embodiments, the application is configured to allow a plurality of individuals to create genetic data profiles associated with a personal identifier. Non-limiting examples of personal identifiers are a mobile phone number, a social security number, or any personal identification number. One of ordinary skill will understand many different personal identifiers may be used and are contemplated for use with the present technology. For example, a first individual/user referred to herein as “Cousin X”, and a second individual/user referred to herein as “Cousin Y” may create genetic data profiles associated with their mobile phone numbers.

In some embodiments, genetic data profiles are protected by security measures. Non-limiting examples of security measures include a password, fingerprint, voiceprint, iris/retinal scans, digital certificates, benefit plan participation number, private health care authorization/access number, or other personal identification number. For example, Cousin X and Cousin Y protect their genetic data profiles associated with their mobile phone numbers with personal passwords.

In various embodiments, the application is configured to allow individuals/users to search for the genetic data of other individuals by a variety of methods including personal identifiers. For example, Cousin X may search for the genetic data profile of Cousin Y by using Cousin Y's personal identifier, such as Cousin Y's mobile phone number. Likewise, Cousin Y may search for the genetic data profile of Cousin X by using Cousin X's mobile phone number. Further, the application functionality may require Cousin X and Cousin Y to enter security measures. For example, in some embodiments, Cousin X is required to enter his password together with his mobile phone number as well as Cousin Y's mobile phone number, and Cousin Y is required to enter his password together with his mobile phone number and Cousin X's mobile phone number. Further, the application functionality may require that all or some of these entries be made within a prescribed period of time, such as one to five minutes. In some embodiments, the type of security measures and/or entries required to be entered by the user to enable certain functionality of application may be a function of the type of device the client is running on as well as other conditions. For example, such other conditions may include physical proximity of one or more client devices (e.g., clients 170₁-170ₓ). For example, application may not require entry of a password if both client devices (e.g., clients 170₁-170ₓ) are smartphones that are within ten feet of each other or within Bluetooth range of each other. In some embodiments, such conditions may be set as preferences by a user.

In various embodiments, the application and/or the client and/or a system (e.g., system 100 and system 200), may automatically detect smartphones and/or the mobile phone numbers of either or both of Cousin X and Y, and fill in such numbers in the application so that Cousin X and Cousin Y only have to manually enter their own respective passwords and/or simply push a button to enable certain functionality of the application. In some embodiments, the automatic detection is performed by application and/or the client utilizing short range telecommunications systems and protocols such as Bluetooth. For example, Cousin X's client device may be in Bluetooth range of Cousin Y's client device. At least one Bluetooth application on one client device detects the Bluetooth application on the other client device and notifies the other client device to commence running (“wakeup” if asleep) and/or to notify a user of proximity of a client device. Depending on pre-defined preferences of Cousin X and Y, their client devices can either display the name and/or mobile phone number of user(s) in proximity or wait for authorization to do so. In all these examples, client devices (e.g., clients 170₁-170ₓ) may or may not be communicating with application. In a further example, each or both Cousins X and Y may manually activate their client device using Bluetooth or otherwise to initiate the exchange of data describe above.

According to various embodiments, the application also tracks the location of a user device (e.g., clients 170₁-170ₓ). The application may generate or select one or more individuals for a user to compare his or her genetic data profile. For example, if Cousin X and Cousin Y are in close geographic location based on application and/or the system (e.g., system 100 and system 200) tracking their locations via GPS (Global Positioning System), the application may suggest that Cousin X selects Cousin Y for comparison with his or her genetic data profile. Likewise, the application may suggest that Cousin Y selects Cousin X for comparison of his or her genetic data profile because of their close geographic proximity. Such suggestions may be a function of geographic location and/or specified pre-defined preferences entered by users and stored in the system and/or the client. For example, the predefined user preferences may include never making suggestions, making suggestions only if another user is within a specified distance, making or not making suggestions as a function of the degree of relationship determined by a comparison of the genetic data of the users. For further example, whether the application makes a suggestion may be a function of meeting a set of conditions pre-defined by the user.

According to some embodiments, the application may analyze and compare the genetic data from the genetic data profiles of the individuals that select each other. Non-limiting examples of genetic data analysis is determining a genealogical relationship between individuals using single-nucleotide polymorphisms (“SNPs”) on autosomal DNA (“atDNA”), and/or SNPs on the Y chromosome (“yDNA”), and/or repeat sections of mitochondria DNA (“mtDNA”). One of ordinary skill will appreciate that similar genetic data analyses fall within the scope of these methods/systems and are likewise contemplated for use in accordance with the present technology. Additionally, a probabilistic estimate of the genealogical relationship may also be part of the genetic data analysis.

In some embodiments, after the genetic data analysis is complete a genetic report is sent to each user. For example, after Cousin X and Cousin Y select each other and enter the necessary security measures, the application compares their genetic data. In exemplary embodiments, genetic data analysis is comparing SNPs on atDNA. In a first exemplary embodiment, genetic data analysis shows a 100% match, thus, the genealogical relationship between Cousin X and Cousin Y is likely identical twins or clones with 99% certainty. In a second exemplary embodiment, genetic data analysis shows a 50% match, thus, the genealogical relationship between Cousin X and Cousin Y is likely parent/child/sibling with 98% certainty. In a third exemplary embodiment, genetic data analysis shows a 25% match, thus, the genealogical relationship between Cousin X and Cousin Y is likely grandparent, uncle, etc. with a 95% certainty.

In various embodiments, a genetic data report is sent to both Cousin X and Cousin Y with the results of the genetic data analysis. For example, in the first exemplary embodiment a genetic data report is sent to Cousin X and Cousin Y reporting that their genealogical relationship is twins with 99% certainty. In the second exemplary embodiment, a genetic data report is sent to Cousin X and Cousin Y reporting that their genealogical relationship is parent/child/sibling with 98% certainty. In the third exemplary embodiment, a genetic data report is sent to Cousin X and Cousin Y reporting that their genealogical relationship is grandparent, uncle, etc. with a 95% certainty. Further, Cousin X and Cousin Y may confirm the genealogical relationship in the genetic data report and this confirmation data is stored in a database. For example, in the first exemplary embodiment Cousin X and Cousin Y may confirm that they are identical twins or clones and this confirmation data is stored in a database. In some embodiments, a threshold of certainty about the relationship will be established either by the user or otherwise and potential genetic relationships having a certainty below that threshold will not be disclosed in the report.

In some embodiments, a user's date of birth is associated with his genetic information and is used to adjust the probabilities reported for a genealogical relationship. For example, if Cousin X and Cousin Y share 50% of genetic material and have birthdays 2 years apart, they are more likely to be siblings than a parent and child. For further example, if Cousin X and Cousin Y share 50% of their genetic material and have birthdays 50 years apart they are more likely to be parent/child than siblings, with the older being the parent.

In some embodiments, a user may define a set of preferences about what kind of relationships may be reported based on his genetic information. For example Cousin X may elect to not permit disclosure of any relationship concerning progeny, but would permit disclosure of relationships such as cousins or siblings.

In some embodiments a user may define in advance that any other user, or some subset of users meeting specified qualifications, may compare their genetic information to his, without the need for further consent from the first user such as entry of passwords or other security measures. For example, Cousin X may set a preference that any user paying him a monetary fee or other specified consideration may compare their genetic profile to his without his additional consent and receive a report concerning their genealogical relationship (such a paid user is referred to herein as a Paid User or a Paid Cousin). For further example, Paid Cousin X may be a celebrity. In some embodiments, the application and/or the system may condition operation of certain functions, such as report generation, data comparisons, etc. to confirmation of receipt of monetary consideration or the occurrence of a condition. For example, the application and/or the system (e.g., system 100 and system 200) transmit a report concerning a user's relationship to a Paid User only if the application and/or the system have/has confirmed payment of a required consideration by the user. In some embodiments, a Paid User and/or a user such as Cousin X or Cousin Y is also a shareholder in a for profit company using or owning or controlling use of the application and/or the system.

The present technology that includes “application-based genetic data analysis” also incorporates methods and/or systems for exchanging data for an equity financial interest in a company that uses the data. In some embodiments, an individual person (e.g., Paid User and/or a user such as Cousin X or Cousin) fully owns and controls personal data, or an individual person has use, disposition, and/or partial legal control of personal data. According to some embodiments, a user of the system (e.g., Paid User and/or a user such as Cousin X or Cousin) is the individual person partially or fully owning or controlling their personal data.

In various embodiments, personal data is an individual's (e.g., Paid User and/or a user such as Cousin X or Cousin) whole or partial genome sequence data and their whole or partial personal electronic medical records. An individual's genome sequence data is an example of personal data that an individual may fully or partially own and control.

Additionally, the application may include GUIs that provide Cousin X and Cousin Y with information about the genetic data report. The application may provide social networking functions, allowing users to interact with one another, send and receive messages, chat with other users, upload photographs, post reviews, and so forth.

According to some embodiments, the present technology is directed to a method for analyzing and comparing genetic data. The method includes receiving genetic data from a user. The method also includes analyzing and comparing the genetic data based on one or more selections from the user and/or user geographic location and/or user mobile telephone number. The method may further include generating a genetic data report. The genetic data report is then provided for display to the user.

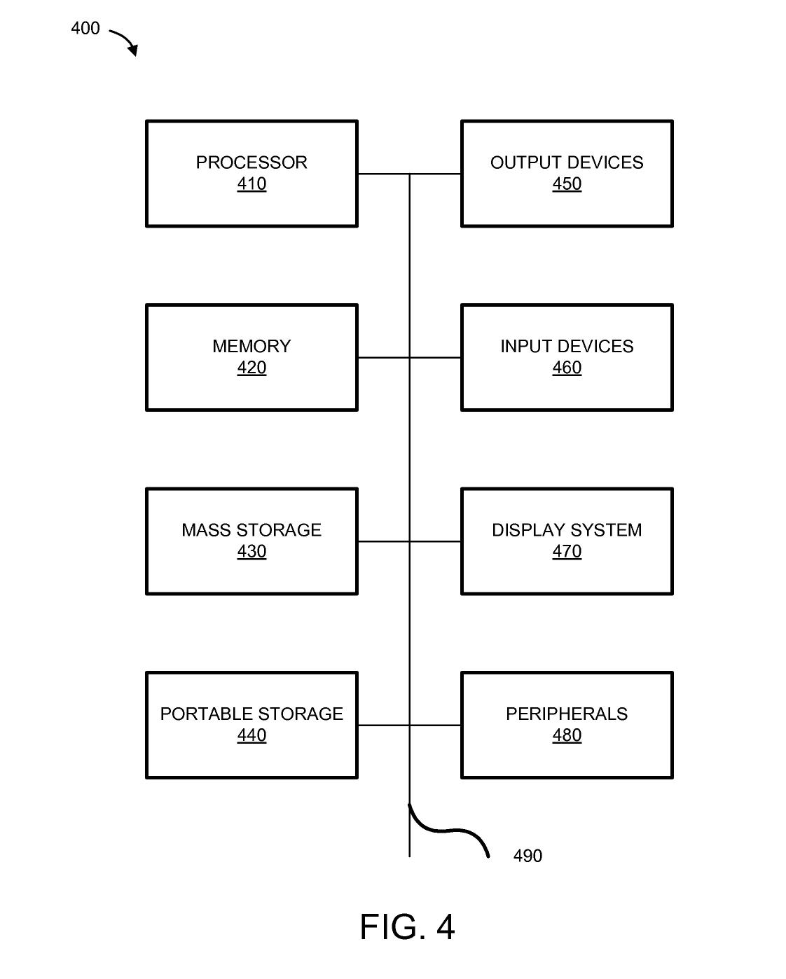

FIG. 1 is a simplified block diagram of a system 100 according to exemplary embodiments of the present technology. The architecture comprises a server system that is configured to provide various functionalities, which are described in greater detail throughout this document. Generally the system 100 is configured to communicate with client devices. Client devices may include, for example, a Smartphone, a laptop, a computer, or other similar computing device. An example of a computing device that can be utilized in accordance with the present technology is described in greater detail with respect to FIG. 4.

The system 100 may communicatively couple with clients via a public or private network. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection, and the like. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS, CDPD (cellular digital packet data), RIM (Research in Motion, Limited) duplex paging network, Bluetooth radio, or an IEEE 802.11-based radio frequency network, and the like. A network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking, and the like.

The system 100 in FIG. 1 generally comprises application programming interface(s) 110, public application programming interface(s) 120, gateway server(s) 130, and switch 140. Application programming interface(s) 110, gateway server(s) 130, and switch 140 form sub-system 150, which may also be referred to as the internal data equity exchange system. System 100 also includes consumer applications 160₁-160_{y}, the consumer applications 160₁-160_{y} may communicate bilaterally with gateway server(s) 130 via application programming interface(s) 110. System 100 also includes clients 170₁-170ₓ. Clients 170₁-170ₓ may communicate bilaterally with gateway server(s) 130 via switch 140.

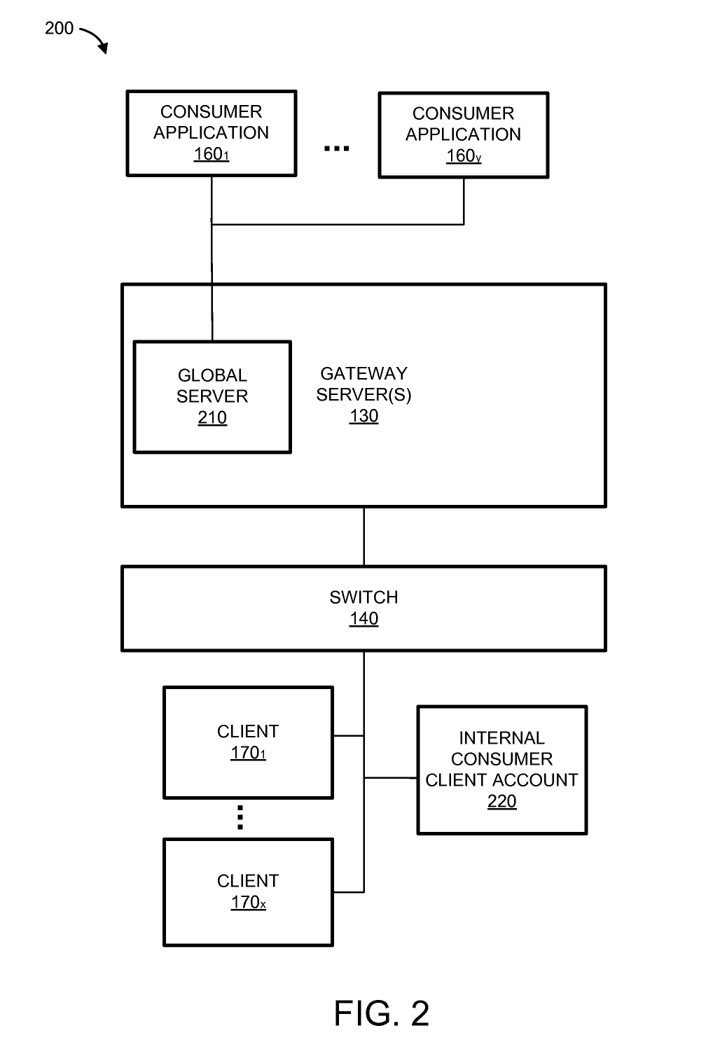

FIG. 2 is a simplified block diagram of a system 200 according to exemplary embodiments of the present technology. The system 200 in FIG. 2 includes the consumer applications 160₁-160_{y}. The system 200 further includes the gateway server(s) 130 with global server 210. The system 200 also includes the Clients 170₁-170ₓ, the switch 140, and internal consumer client account 220. In various embodiments, the internal consumer client account 220 may be an account of the user.

In various embodiments, the switch 140 adds additional security to messages sent within the system 100 and system 200 by signing, authenticating, and applying business rules to the messages during the routing process.

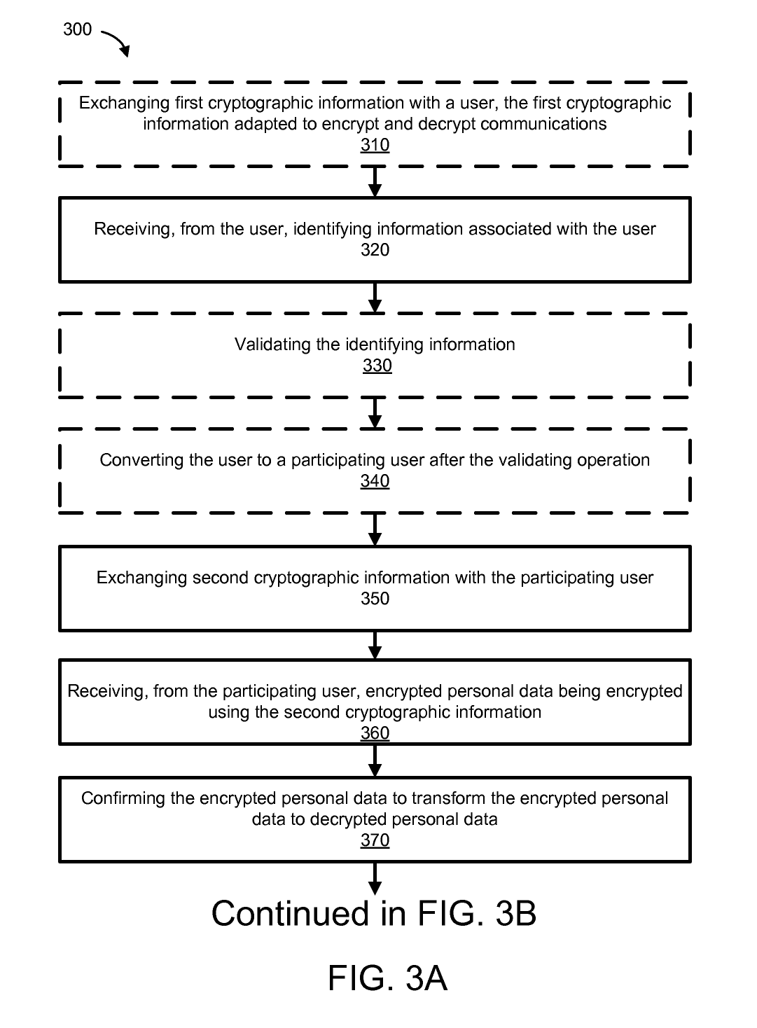

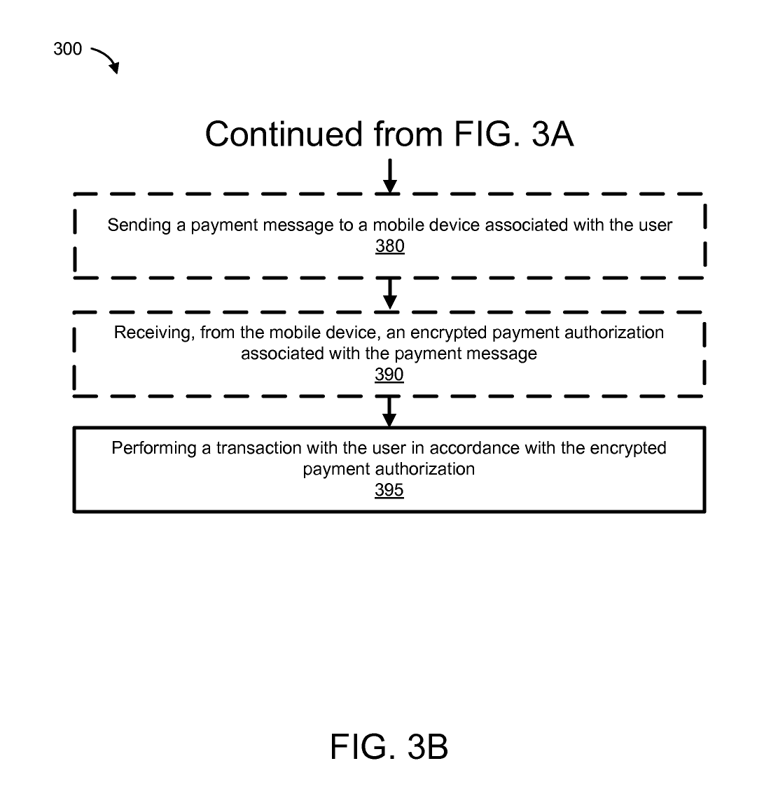

FIG. 3A is a flow diagram illustrating an example method according to exemplary embodiments of the present technology. Optional steps are shown with dashed lines. FIG. 3A illustrates a method 300 for conducting a secure transaction over a network. In various embodiments, method 300 is performed by a computing system, as described in relation to FIG. 4. At step 310, the method begins by exchanging first cryptographic information with a user. The first cryptographic information is adapted to encrypt and decrypt communications. At step 320, the method continues by receiving, from the user, identifying information associated with the user. At step 330, the method continues by validating the identifying information. At step 340, the method continues by converting the user to a participating user after the validating operation. At step 350, the method continues by exchanging second cryptographic information with the participating user. The second cryptographic information is adapted to encrypt and decrypt communications. At step 360, the method continues by the method continues by receiving, from the participating user, encrypted personal data being encrypted using the second cryptographic information. The encrypted personal data being received via a data equity programmable user interface. At step 370, the method continues by confirming the encrypted personal data to transform the encrypted personal data to decrypted personal data. The confirming of the encrypted personal data including decrypting, by the system, the encrypted personal data using the second cryptographic information.

FIG. 3B is a flow diagram illustrating an exemplary method according embodiments of the present technology. FIG. 3B illustrates additional steps of the method 300 that may be performed for the present technology At step 380, the method continues by sending a payment message to a mobile device associated with the user. The payment message being encrypted by the system using the first cryptographic information to form an encrypted payment message. At step 390, the method continues by receiving, from the mobile device, an encrypted payment authorization associated with the payment message. The encrypted payment authorization being encrypted using the first cryptographic information and being decrypted by the system using the first cryptographic information. At step 395, the method continues by performing a transaction with the user in accordance with the encrypted payment authorization.

It will be understood that the functionalities described herein, which are attributed to the system 100 may also be executed within a client. That is, a client may be programmed to execute the functionalities described herein. In other instances, the system 100, and a client may cooperate to provide the functionalities described herein, such that a client is provided with a client-side application that interacts with the system 100 such that the system 100 and a client operate in a client/server relationship. Complex computational features may be executed by the gateway server(s) 130, while simple operations that require fewer computational resources may be executed by a client, such as data gathering and data display.

In general, a user interface module may be executed by the system 100 to provide various programmable user interfaces such GUIs that allow users to interact with the system 100. In some instances, GUIs are generated by execution of an application itself. Users may interact with the system 100 using, for example, a client. The system 100 may generate web-based interfaces for a client.

FIG. 4 illustrates an exemplary computer system 400 that may be used to implement some embodiments of the present invention. The computer system 400 in FIG. 4 may be implemented in the contexts of the likes of computing systems, networks, servers, or combinations thereof. The computer system 400 in FIG. 4 includes one or more processor unit(s) 410 and main memory 420. Main memory 420 stores, in part, instructions and data for execution by processor unit(s) 410. Main memory 420 stores the executable code when in operation, in this example. The computer system 400 in FIG. 4 further includes a mass data storage 430, portable storage device 440, output devices 450, user input devices 460, a graphics display system 470, and peripheral device(s) 480.

The components shown in FIG. 4 are depicted as being connected via a single bus 490. The components may be connected through one or more data transport means. Processor unit(s) 410 and main memory 420 are connected via a local microprocessor bus, and the mass data storage 430, peripheral device(s) 480, portable storage device 440, and graphics display system 470 are connected via one or more input/output (I/O) buses.

Mass data storage 430, which can be implemented with a magnetic disk drive, solid state drive, or an optical disk drive, is a non-volatile storage device for storing data and instructions for use by processor unit(s) 410. Mass data storage 430 stores the system software for implementing embodiments of the present disclosure for purposes of loading that software into main memory 420.

Portable storage device 440 operates in conjunction with a portable non-volatile storage medium, such as a flash drive, floppy disk, compact disk, digital video disc, or Universal Serial Bus (USB) storage device, to input and output data and code to and from the computer system 400 in FIG. 4. The system software for implementing embodiments of the present disclosure is stored on such a portable medium and input to the computer system 400 via the portable storage device 440.

User input devices 460 can provide a portion of a user interface. User input devices 460 may include one or more microphones, an alphanumeric keypad, such as a keyboard, for inputting alphanumeric and other information, or a pointing device, such as a mouse, a trackball, stylus, or cursor direction keys. User input devices 460 can also include a touchscreen. Additionally, the computer system 400 as shown in FIG. 4 includes output devices 450. Suitable output devices 450 include speakers, printers, network interfaces, and monitors.

Graphics display system 470 include a liquid crystal display (LCD) or other suitable display device. Graphics display system 470 is configurable to receive textual and graphical information and processes the information for output to the display device.

Peripheral device(s) 480 may include any type of computer support device to add additional functionality to the computer system 400.

The components provided in the computer system 400 in FIG. 4 are those typically found in computer systems that may be suitable for use with embodiments of the present disclosure and are intended to represent a broad category of such computer components that are well known in the art. Thus, the computer system 400 in FIG. 4 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 400 may be implemented as a cloud-based computing environment, such as a virtual machine operating within a computing cloud. In other embodiments, the computer system 400 may itself include a cloud-based computing environment, where the functionalities of the computer system 400 are executed in a distributed fashion. Thus, the computer system 400, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer system 400, with each server (or at least a plurality thereof) providing processor and/or storage resources. These servers manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical, magnetic, and solid-state disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as JAVA, SMALLTALK, C++ and the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

What is claimed is:

1. A system, comprising:
a secure switch operable to communicate bilaterally with at least one consumer application;
at least one gateway server electronically communicating with the secure switch and including a processor and a memory communicatively coupled to the processor, the memory storing instructions executable by the system to perform a method, the method comprising:
exchanging first cryptographic information with a user, the first cryptographic information adapted to encrypt and decrypt communications;
receiving, from the user, identifying information associated with the user;
validating the identifying information;
converting the user to a participating user after the validating operation;
exchanging second cryptographic information with the participating user, the second cryptographic information adapted to encrypt and decrypt communications;
receiving encrypted personal data associated with the participating user and being encrypted using the second cryptographic information, the encrypted personal data being received via a data equity programmable user interface;
confirming the encrypted personal data to transform the encrypted personal data to decrypted personal data, the confirming of the encrypted personal data including decrypting, by the system, the encrypted personal data using the second cryptographic information;
sending a payment message to a mobile device associated with the participating user, the payment message being encrypted by the system using the first cryptographic information to form an encrypted payment message;
receiving, from the mobile device, an encrypted payment authorization associated with the payment message, the encrypted payment authorization being encrypted using the first cryptographic information, being decrypted by the system using the first cryptographic information; and
performing a transaction with the participating user in accordance with the encrypted payment authorization; and
at least one application programming interface electronically communicating with the at least one gateway server and adapted to communicate bilaterally with at least one consumer application.

2. The system of claim 1, wherein the transaction is associated with an equity financial interest in a company that uses the encrypted personal data associated with the participating user.

3. The system of claim 2, wherein the encrypted personal data associated with the participating user is any one or more than one of personal genomic data, familial genomic data, group genomic data, personal medical records, familial medical records, and group medical records.

4. The system of claim 2, wherein the encrypted personal data associated with the participating user is any individually generated content including one or more than one of a review, a comment, and an opinion.

5. The system of claim 2, wherein the company is at least partially owned by the participating user and a threshold level of equity in the company is owned by individuals that contribute data to the company.

6. The system of claim 2, wherein the equity financial interest is granted to the participating user, a measure of the equity financial interest in the company granted to the participating user being a function of a quality of the encrypted personal data associated with the participating user.

7. The system of claim 6, wherein the quality of the encrypted personal data associated with the participating user is based on a quantity of the encrypted personal data and a timing of when the encrypted personal data is received by the system.

8. The system of claim 6, wherein the quality of the encrypted personal data associated with the participating user is based on a content of the encrypted personal data, the content including a presence of a specific genetic mutation.

9. The system of claim 1, wherein:
the secure switch electronically communicates with an internal consumer client account; and
the performing of the transaction with the participating user uses the secure switch and is associated with the internal consumer client account, the internal consumer client account being associated with a unique identifier associated with the participating user.

10. The system of claim 1, wherein the identifying information uses at least one of: a digital certificate of the user, a benefit plan participation number of the user, and a private health care access number of the user.

11. The system of claim 1, wherein the identifying information includes at least one of: a fingerprint of the user, a voiceprint of the user, an iris scan of the user, and an retinal scan of the user.

12. A system, comprising:
a secure switch operable to communicate bilaterally with at least one consumer application;
at least one gateway server electronically communicating with the secure switch and including a processor and a memory communicatively coupled to the processor, the memory storing instructions executable by the system to perform a method, the method comprising:
receiving encrypted genetic personal data associated with a user via a data equity programmable user interface;
confirming the encrypted genetic personal data to transform the encrypted genetic personal data to decrypted genetic personal data, the confirming of the encrypted genetic personal data including decrypting, by the system, the encrypted genetic personal data;
comparing the decrypted genetic personal data with genetic data associated with at least one second user; and
generating a genetic data report as a function of the comparing operation; and
at least one application programming interface electronically communicating with the at least one gateway server and adapted to communicate bilaterally with at least one consumer application.

13. The system of claim 12, wherein the at least one application programming interface is adapted to communicate bilaterally with the data equity programmable user interface, the data equity programmable user interface being configured to perform:
searching for genetic data of an individual by geographic location of a client device associated with the individual.

14. The system of claim 12, wherein the comparing of the decrypted genetic personal data with genetic data associated with at least one second user is determined by one or more selections of at least one of the user and the second user, the selections including at least a personal identifier of at least one of the user and the second user.

15. The system of claim 12, wherein the comparing of the decrypted genetic personal data with genetic data associated with at least one second user includes genetic data analysis using at least one of: single-nucleotide polymorphisms (SNPs) on autosomal deoxyribonucleic acid (DNA), SNPs on a Y chromosome, and repeat sections of mitochondria DNA.

16. The system of claim 12, wherein the genetic data report includes a genealogical relationship between the user and the second user, the genealogical relationship including a percent certainty of the genealogical relationship.

17. The system of claim 16, wherein the percent certainty of the genealogical relationship is compared to a threshold of certainty of the genealogical relationship, the threshold of certainty being used in the genetic data report.

18. The system of claim 12, wherein the at least one gateway server electronically communicating with the secure switch and including the processor and the memory communicatively coupled to the processor, the memory storing instructions executable by the system to perform the method, the method further comprising:
performing a transaction with the user based on the encrypted genetic personal data, the transaction being associated with an equity financial interest in a company that uses the encrypted genetic personal data associated with the user.

19. The system of claim 18, wherein the equity financial interest in the company is granted to the user, a measure of the equity financial interest in the company being a function a quality of the encrypted genetic personal data and a timing of when the encrypted genetic personal data is received by the system.

20. A system, comprising:
a secure switch operable to communicate bilaterally with at least one consumer application;
at least one gateway server electronically communicating with the secure switch and including a processor and a memory communicatively coupled to the processor, the memory storing instructions executable by the system to perform a method, the method comprising:
receiving encrypted personal data associated with a user via a data equity programmable user interface;
confirming the encrypted personal data to transform the encrypted personal data to decrypted personal data, the confirming of the encrypted personal data including decrypting, by the system, the encrypted personal data;
performing a transaction with the user, the transaction being associated with an equity financial interest in a company that uses the encrypted personal data associated with the user, the equity financial interest being granted to the user, a measure of the equity financial interest granted to the user being a function of a quality of the encrypted personal data associated with the user; and
at least one application programming interface electronically communicating with the at least one gateway server and adapted to communicate bilaterally with at least one consumer application.
